(19) United States
(12) Patent Application Publication
(10) Pub. No.: US 2016/0112930 A1
(43) Pub. Date: Apr. 21, 2016

(54) SYSTEM AND METHOD INCLUDING DISTRIBUTED INTELLIGENCE AMONG COMMUNICATION NODES

(71) Applicant: ALCATEL-LUCENT USA INC., Murray Hill, NJ (US)

(72) Inventors: Madhav Moganti, Edison, NJ (US); Anish Sankalia, Lawrenceville, GA (US); Mayuresh Pandit, Cedar Knolls, NJ (US)

(21) Appl. No.: 14/518,135

(22) Filed: Oct. 20, 2014

(51) Int. Cl. H04W 40/20; H04L 5/00; H04W 16/14

(52) U.S. Cl. CPC H04W 40/20; H04W 16/14; H04L 5/0048

(57) ABSTRACT

An illustrative example communication system designed according to an embodiment of this invention includes a controller and a data storage accessible by the controller. The data storage includes information indicating possible communication links among communication devices within a selected region. At least one node communicates with user devices. The at least one node has an intelligence gathering module that detects at least one signal from at least one other network device capable of communicating with user devices, and processes information regarding the at least one other network device based on the at least one detected signal. The at least one node communicates the information regarding the at least one other network device to the controller and the controller includes the information regarding the at least one other network device in the stored information of the data storage.

### 1. TECHNICAL FIELD

The subject matter of this document pertains to communication networks. More particularly, and without limitation, the subject matter of this document pertains to a communication network including distributed intelligence among communication nodes to facilitate communications for user devices.

### 2. BACKGROUND

It is becoming increasingly possible to communicate with a variety of devices using wired links or wireless communication protocols. The increasing power of end user devices requires more bandwidth. Wireless operators are challenged to meet the growing mobile Internet demands without expansions or increases in spectrum. At the same time, wireless spectrum resources are becoming increasingly scarce. There is a need for better frequency utilization.

One proposed solution includes dynamic frequency allocation. This approach is limited in that it may not be coordinated across multiple service providers. Additionally, current wireless communication nodes may not have sufficient application layer capability to implement multi-access, multimode or multi-mesh algorithms even if the latter were available.

### SUMMARY

An illustrative example communication system designed according to an embodiment of this invention includes a controller and a data storage accessible by the controller. The data storage includes information indicating possible communication links among communication devices within a selected region. At least one node communicates with user devices. The at least one node has an intelligence gathering module that detects at least one signal from at least one other network device capable of communicating with user devices, and processes information regarding the at least one other network device based on the at least one detected signal. The at least one node communicates the information regarding the at least one other network device to the controller and the controller includes the information regarding the at least one other network device in the stored information of the data storage.

In an example embodiment of a system having one or more features of the previous paragraph, the stored information in the data storage comprises: information regarding the at least one node, information regarding a communication history of the node, information regarding the at least one other network device, and information regarding at least one possible communication link between the at least one node and the at least one other network device.

In an example embodiment of a system having one or more features of any of the previous paragraphs, the intelligence gathering module detects at least a pilot signal from the at least one other network device.

In an example embodiment of a system having one or more features of any of the previous paragraphs, the at least one node is operated by a first service provider and the at least one other network device is operated by a second, different service provider.

In an example embodiment of a system having one or more features of any of the previous paragraphs, the controller uses the stored information to determine routing information for a communication session involving at least one user device and at least one of the at least one node or the at least one other network device.

In an example embodiment of a system having one or more features of any of the previous paragraphs, the stored information comprises a mapping of network information that includes a plurality of communication nodes capable of routing communications on behalf of at least one user device and information regarding respective locations of the plurality of communication nodes.

In an example embodiment of a system having one or more features of any of the previous paragraphs, the controller instructs the at least one node to attempt to obtain at least one signal from a specified other network device based on the stored information.

In an example embodiment of a system having one or more features of any of the previous paragraphs, the at least one node comprises a wireless base station, and the at least one other network device comprises an access point that is at least one of a transceiver of another base station, a femto cell transceiver, a pico cell transceiver, a WiFi node transceiver, a relay node, a radio remote head, a cloud radio access network, or a distributed radio access network.

In an example embodiment of a system having one or more features of any of the previous paragraphs, the at least one node comprises a memory portion, the memory portion includes an indication of the information processed by the intelligence gathering module, the memory portion includes processed past communication history information, and the at least one node uses the indication of the information in the memory portion to (i) facilitate a communication for a user device, or (ii) obtain additional information regarding at least one other network device.

An illustrative example communication method designed according to an embodiment of this invention includes storing information in a data storage. The stored information indicates possible communication links among communication devices within a selected region. An intelligence gathering module of at least one node detects at least one signal from at least one other network device. The at least one node is capable of communication with user devices. The at least one other network device is also capable of communicating with user devices. Information regarding the at least one other network device is processed by the intelligence gathering module based on the at least one detected signal. The processed information regarding the at least one other network device is included in the stored information in the data storage.

In an example embodiment of a method having one or more features of the previous paragraph, the stored information in the data storage comprises information regarding the at least one node, information regarding the at least one other network device, information regarding a past communication history of the at least one node, and information regarding a possible communication link between the at least one node and the at least one other network device, the information.

In an example embodiment of a method having one or more features of any of the previous paragraphs, the signaling module detects at least a pilot signal from the at least one other network device.

An example embodiment of a method having one or more features of any of the previous paragraphs includes operating the at least one node by a first service provider and wherein the at least one other network device is operated by a second, different service provider.

An example embodiment of a method having one or more features of any of the previous paragraphs includes using the stored information to determine routing information for a communication session involving at least one user device and at least one of the at least one node or the at least one other network device.

In an example embodiment of a method having one or more features of any of the previous paragraphs, the stored information comprises a mapping of network information that includes a plurality of communication nodes capable of routing communications on behalf of at least one user device and information regarding respective locations of the plurality of communication nodes.

An example embodiment of a method having one or more features of any of the previous paragraphs includes instructing the at least one node to attempt to obtain at least one signal from a specified other network device based on the stored information.

In an example embodiment of a method having one or more features of any of the previous paragraphs, the at least one node comprises a wireless base station; and the at least one other network device comprises an access point that is at least one of a transceiver of another base station, a femto cell transceiver, a pico cell transceiver, a WiFi node transceiver, a relay node, a radio remote head, a cloud radio access network, or a distributed radio access network.

An example embodiment of a method having one or more features of any of the previous paragraphs includes including an indication of the information processed by the intelligence gathering module in a memory portion of the at least one node; including processed information regarding a communication history in the memory portion; and the at least one node using at least one of the indication or the processed information of the memory portion to (i) facilitate a communication for a user device, or (ii) obtain additional information regarding at least one other network device.

An illustrative example communication node designed according to an embodiment of this invention includes a transceiver for communicating with user devices. An intelligence gathering module detects at least one signal from at least one other network device capable of communicating with user devices. The intelligence gathering module processes information regarding the at least one other network device based on the at least one detected signal. A memory portion at least temporarily includes an indication of the processed information and processed information regarding a communication history. The node uses at least one of the indication or the processed information of the memory portion to (i) facilitate a communication for a user device, or (ii) obtain additional information regarding at least one other network device.

In an example embodiment of a device having one or more features of the previous paragraph, the node communicates the information regarding the at least one other network device to a network controller for inclusion in stored information indicating possible communication links among communication devices within a selected region.

The various features and advantages of at least one embodiment of this invention will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of a communication system according to an embodiment of this invention.

FIG. 2 schematically illustrates a variety of communication devices that may be discovered by a node that includes features of the embodiment represented in FIG. 1.

FIG. 3 schematically represents mapping-type information that may be included in a data storage of an example embodiment.

FIG. 4 is a flowchart diagram summarizing an example approach using distributed intelligence in a communication network.

### DETAILED DESCRIPTION

At least one disclosed embodiment of a communication system and method includes distributed intelligence among at least some communication nodes. The distributed intelligence and information gathered through that intelligence is useful for facilitating more efficient or effective communications for a variety of end user devices.

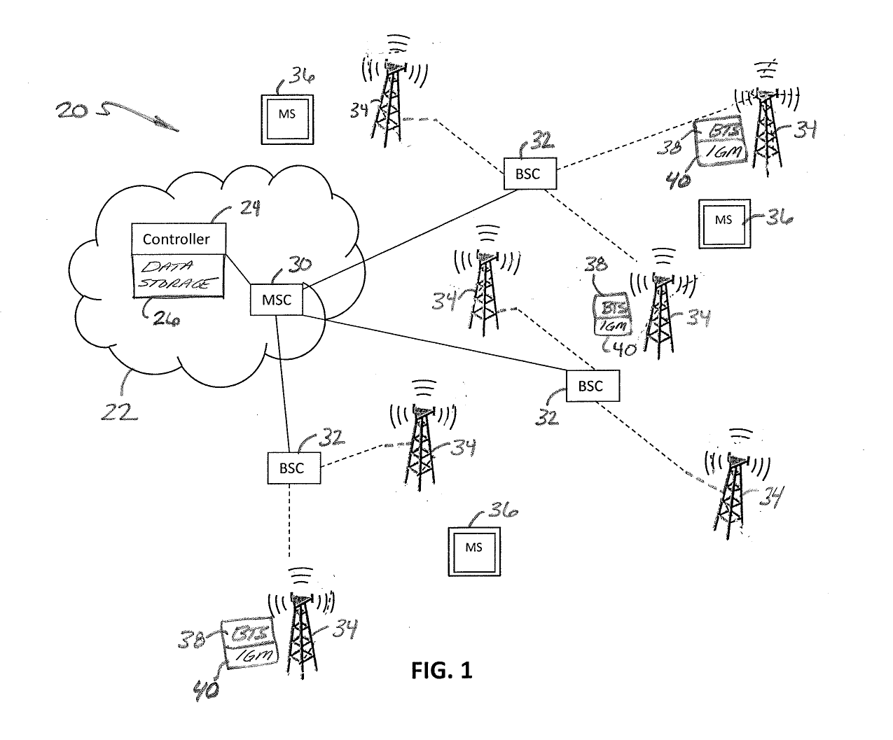

FIG. 1 schematically illustrates selected portions of a communication system 20 designed according to an embodiment of this invention. The system 20 includes a network 22 that includes a controller 24 and an associated data storage 26. The controller 24 is capable of accessing the data storage 26 to read from stored information in the data storage 26 or to write new information into the stored information. The controller 24 and the data storage 26 each comprise hardware in this embodiment.

In some example embodiments the stored information in the data storage 26 includes information regarding possible communication links among various communication devices in a selected region. The stored information may be considered a mapping of communication devices that provides an indication of relationships among the devices. In some embodiments the stored information includes information regarding a communication history of various nodes or communication devices in the selected region. Such information is useful to the controller 24 (or another processor in the system 20) for routing communications on behalf of user devices or subscribers.

The example system 20 includes network elements, such as a mobile switching center 30, base station controllers 32 and nodes 34. In the example of FIG. 1, the nodes 34 comprise base stations, such as cellular base station transceivers, that are configured for communications with end user devices 36 (e.g., mobile stations) over wireless links. The nodes 34 communicate with the controller 24 over a backhaul link through an associated base station controller 32 and the mobile switching center 30, for example. In some embodiments the nodes 34 communicate directly with the controller 24 over a dedicated link (wireless or backhaul).

At least one of the nodes 34 includes an ability to gather intelligence about other network communication devices. In FIG. 1 several of the nodes 34 include a base station transceiver (BTS) portion 38 and an intelligence gathering module (IGM) 40. The BTS portion 38 is configured for known wireless communications for end user devices or mobile stations 36. The IGM 40 is configured for at least detecting signals from other network communication devices for gathering information regarding such devices and processing that information. The IGM 40 is part of distributed intelligence among the nodes 34 because the information processed by the IGM 40 is used for facilitating communications for at least one mobile station 36. In the illustrated example, the controller 24 uses the information gathered by any of the IGMs 40 to augment or update the information in the data storage 26. The additional information better equips the controller 24 and the network 22 for various purposes, such as routing communications along possible links among the communication devices that are identified within the stored information.

In some examples, the controller 24 is part of another communication device within the network 22, such as a radio network controller (RNC). In other examples, the controller 24 may be implemented as a separate device that is particularly configured to perform the functions described in this document regarding the example controller. Those skilled in the art who have the benefit of this description will realize what an appropriate placement or configuration of a controller 24 will be to meet their particular needs. Additionally, while the controller 24 is schematically shown as an individual element, the functions or features of the example controller 24 may be disbursed among various communication network elements or devices. Given this description, those skilled in the art will realize what combination of hardware, software and firmware will best meet their particular needs.

The controller 24 receives information from a variety of IGMs 40 associated with a plurality of the nodes 34. That information is placed into the data storage by the controller 24. The information gathered and processed by the IGMs 40 allows the controller 24 to establish or augment stored information regarding a plurality of network communication devices and to make determinations for efficiently facilitating communications based upon that information.

In the illustrated example the IGM 40 either has its own dedicated hardware and software or accesses hardware or software that is already part of the corresponding node 34. Example hardware includes a transceiver for transmitting or receiving signals and a processor configured to determine what to do in response to a detected signal from another network communication device. The node 34 or the IGM 40 need not decipher the information available from detected signals in every instance. Determining the relevant information based on signals detected by the IGM 40 may be done by the processor 24, a processor that is part of the IGM 40 at the node 34, or a combination of them, depending on how much intelligence the particular IGM has.

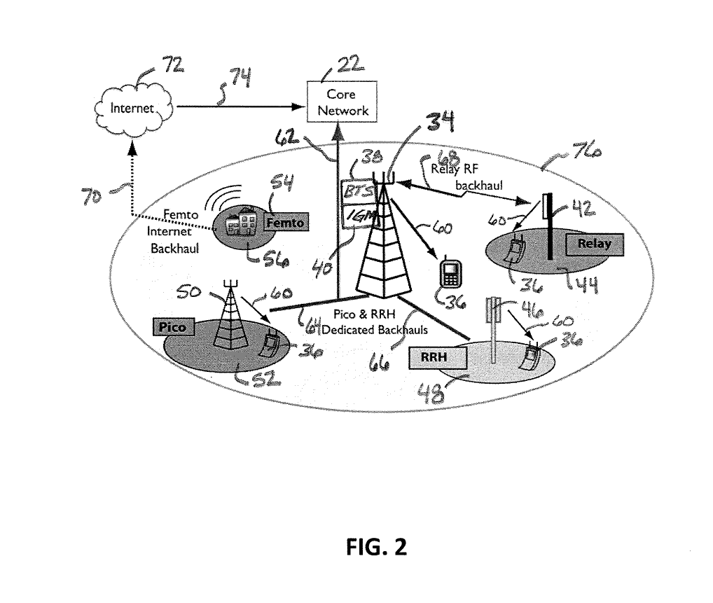

FIG. 2 schematically represents one of the nodes 36 that includes an IGM 40 and a variety of network communication devices about which intelligence or information may be useful for facilitating communications. In this example, a relay node 42 provides a coverage area 44 to relay communications to one or more mobile stations 36. A remote radio head 46 has an associated coverage area 48. A picocell base station 50 establishes a picocell 52. Each of the devices 42, 46 and 50 transmit or broadcast signals, such as a pilot signal, that are detectable by the IGM 40.

FIG. 2 also includes a femto station 54 that establishes a femto cell coverage area 56. Depending on the location and transmit power of the femto station 54, the IGM 40 may be able to detect a pilot signal of the femto station 54 directly. Alternatively, the IGM 40 may learn of the femto station 54 through another device if that other device detects a signal from the femto station 54 and then provides some indication of the detected femto station signal to the node that includes the IGM 40.

A variety of communication links are schematically represented in FIG. 2. One or more of these links may be useful for facilitating communications on behalf of an end user. Wireless links 60 are schematically shown providing wireless communication capability to the illustrated mobile stations 36. A backhaul link 62 is provided between the base station node 34 and the core network 22. A backhaul link 64 is provided between the picocell base station 50 and the core network 22. In this example, the backhaul link 64 also provides a connection between the picocell base station 50 and the base station node 34. Another backhaul link 66 is shown between the remote radio head 46 and the base station node 34. In the example of FIG. 2, a wireless backhaul link 66 is provided between the base station node 34 and the relay node 42. The femto base station 54 utilizes an Internet backhaul link 70 through the Internet 72 over a connection 74 with the core network 22.

The controller 24 utilizes information gathered from the IGM 40 of the base station node 34 for considering one or more of the links shown in FIG. 2 as a possible link for facilitating communications on behalf of an end user within the region represented in FIG. 2.

The manner in which the controller 24 routes communications over one or more of the example links may be accomplished using known routing algorithms or techniques. Assigning a particular node for a particular portion of a communication may be accomplished using known handoff techniques, for example, and other known algorithms for selecting an appropriate access point or node for handling a particular communication at a particular time. Given this description, those skilled in the art will be able to realize what known techniques are available for establishing or selecting communication routes for facilitating communications on behalf of an end user taking advantage of information gathered through the IGM 40.

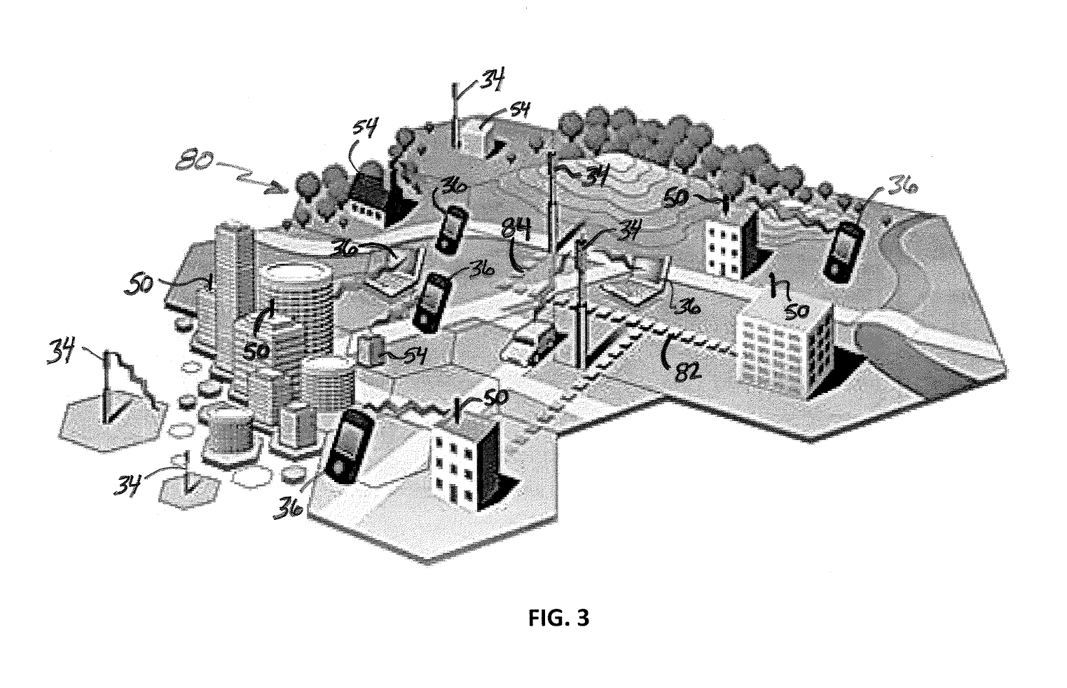

In one example, the information stored in the data storage, which is based at least in part on information obtained and processed by one or more IGMs 40, corresponds to a mapping of network communication devices within a selected region. FIG. 3 schematically illustrates a mapping 80 in graphic form. The stored information within the data storage 26 may include information regarding the geographic locations and relative positions of various communication devices, such as base station nodes 34, picocell base stations 50, femto or WiFi stations 54, among others. One manner in which the stored information is useful to the controller 24 is for considering or determining possible communication links such as those schematically shown at 82 and 84 for routing communications on behalf of one or more end user devices or mobile stations 36. The possible communication links 82 and 84 may comprise wireless links, landline or hardwired links or a network including both types of links, depending on the particular situation.

The IGMs 40 provide the ability for the controller 24 to gain additional information regarding the area surrounding one or more of the network communication devices having a IGM that is capable of detecting signals from other network communication devices, such as their pilot signals.

Given information regarding the locations of the end user devices 36 and information representing the relative positions and coverage areas of the network communication devices shown in FIG. 3, the controller 24 is able to make decisions regarding routing communications on behalf of the end user devices 36.

Of course, the information stored in the data storage 26 has a different format compared to the schematic, graphical representation shown in FIG. 3, however, FIG. 3 provides an individual with a visual picture of the type of information available to the controller 24 from the data storage 26.

In some embodiments, the IGMs 40 have an associated memory portion where information gathered by the IGM 40 is at least temporarily stored at the corresponding node 34. In some examples, the node 34 uses such stored information for a variety of purposes, such as scanning or polling a surrounding area for the presence or availability of other communication network devices that have been previously detected by the IGM 40. To the extent that the node 34 has additional capabilities for making decisions regarding communications, the information that is at least temporarily stored in the memory associated with the IGM 40 may be used for such decisions.

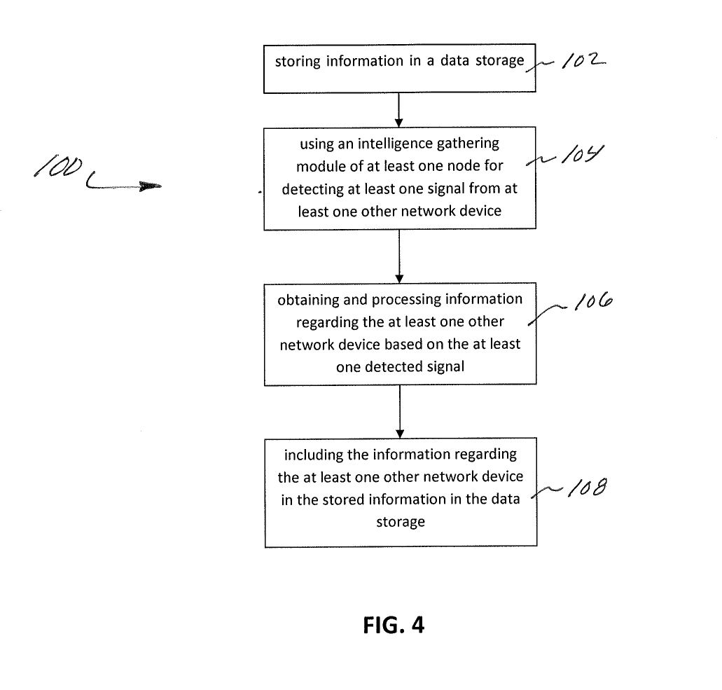

FIG. 4 includes a flowchart diagram 100 that summarizes an example method of managing communications on behalf of end user devices based at least partially upon information gathered by IGMs associated with a plurality of nodes within a network. At 102, information is stored in a data storage. In many embodiments, a base amount of information is stored in the data storage 26 by the network operator given known features of a communication network and communication devices within a selected region.

At 104, a IGM is used for detecting at least one signal from another network communication device. At 106, the example technique includes obtaining information regarding that other network communication device based on the detected signal and processing that information. At 108, the information is included in the stored information within the data storage, which increases the knowledge base for the controller responsible for routing communications, for example. The information gathered by one or more of the IGMs 40 is used by the processor 24 to augment or update a previously stored version of the stored information in the data storage 26.

By including distributed intelligence among a plurality of nodes within a communication network, the disclosed example arrangement opens up additional possibilities for more effective and efficient use of available spectrum for communications, such as wireless communications on behalf of end users. Providing distributed intelligence, such as the IGMs 40, at a plurality of nodes allows for discovering more details regarding communication devices in a selected region.

The features of the disclosed example are not limited to use by a single network provider. Different service providers may be able to discover information regarding communication devices used by other service providers. Those devices may still be useful for routing a particular communication. In other words, the distributed intelligence associated with providing IGMs 40 at a plurality of nodes as described above allows for interaction or cooperation among service providers or between communication devices operated by different providers for one or more communication sessions in a manner that has not been previously possible.

While various features and aspects are described above in connection with one or more particular embodiments, those features and aspects are not necessarily exclusive to the corresponding embodiment. The disclosed features and aspects may be combined in other ways than those specifically mentioned above. In other words, any feature of one embodiment may be included with another embodiment or substituted for a feature of another embodiment.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A communication system, comprising:
a controller;
a data storage accessible by the controller, the data storage including information indicating possible communication links among communication devices within a selected region; and
at least one node that communicates with user devices, the at least one node having an intelligence gathering module;
wherein the intelligence gathering module detects at least one signal from at least one other network device capable of communicating with user devices;
wherein the intelligence gathering module processes information regarding the at least one other network device based on the at least one detected signal;
wherein the at least one node communicates the information regarding the at least one other network device to the controller;
wherein the controller includes the information regarding the at least one other network device in the stored information of the data storage.

2. The system of claim 1, wherein the stored information in the data storage comprises
information regarding the at least one node;
information regarding a communication history of the node;
information regarding the at least one other network device; and
information regarding at least one possible communication link between the at least one node and the at least one other network device.

3. The system of claim 1, wherein the intelligence gathering module detects at least a pilot signal from the at least one other network device.

4. The system of claim 1, wherein the at least one node is operated by a first service provider and the at least one other network device is operated by a second, different service provider.

5. The system of claim 1, wherein the controller uses the stored information to determine routing information for a communication session involving at least one user device and at least one of the at least one node or the at least one other network device.

6. The system of claim 1, wherein the stored information comprises a mapping of network information that includes a plurality of communication nodes capable of routing communications on behalf of at least one user device and information regarding respective locations of the plurality of communication nodes.

7. The system of claim 1, wherein the controller instructs the at least one node to attempt to obtain at least one signal from a specified other network device based on the stored information.

8. The system of claim 1, wherein
the at least one node comprises a wireless base station; and
the at least one other network device comprises an access point that is at least one of
a transceiver of another base station,
a femto cell transceiver,
a pico cell transceiver,
a WiFi node transceiver,
a relay node,
a radio remote head,
a cloud radio access network, or
a distributed radio access network.

9. The system of claim 1, wherein
the at least one node comprises a memory portion;
the memory portion includes an indication of the information processed by the intelligence gathering module;
the memory portion includes processed past communication history information; and
the at least one node uses the indication of the information in the memory portion to (i) facilitate a communication for a user device, or (ii) obtain additional information regarding at least one other network device.

10. A communication method, comprising:
storing information in a data storage, the stored information indicating possible communication links among communication devices within a selected region; and
using an intelligence gathering module of at least one node for detecting at least one signal from at least one other network device, the at least one node being capable of communication with user devices, the at least one other network device being capable of communicating with user devices;
processing information regarding the at least one other network device based on the at least one detected signal; and
including the information regarding the at least one other network device in the stored information in the data storage.

11. The method of claim 10, wherein the stored information in the data storage comprises
information regarding the at least one node;
information regarding the at least one other network device;
information regarding a past communication history of the at least one node; and
information regarding a possible communication link between the at least one node and the at least one other network device, the information.

12. The method of claim 10, wherein the signaling module detects at least a pilot signal from the at least one other network device.

13. The method of claim 10, comprising operating the at least one node by a first service provider and wherein the at least one other network device is operated by a second, different service provider.

14. The method of claim 10, comprising using the stored information to determine routing information for a communication session involving at least one user device and at least one of the at least one node or the at least one other network device.

15. The method of claim 10, wherein the stored information comprises a mapping of network information that includes a plurality of communication nodes capable of routing communications on behalf of at least one user device and information regarding respective locations of the plurality of communication nodes.

16. The method of claim 10, comprising instructing the at least one node to attempt to obtain at least one signal from a specified other network device based on the stored information.

17. The method of claim 10, wherein
the at least one node comprises a wireless base station; and
the at least one other network device comprises an access point that is at least one of
a transceiver of another base station,
a femto cell transceiver,
a pico cell transceiver,
a WiFi node transceiver,
a relay node,
a radio remote head,
a cloud radio access network, or
a distributed radio access network.

18. The method of claim 10, comprising
including an indication of the information processed by the intelligence gathering module in a memory portion of the at least one node;
including processed information regarding a communication history in the memory portion; and
the at least one node using at least one of the indication or the processed information of the memory portion to (i) facilitate a communication for a user device, or (ii) obtain additional information regarding at least one other network device.

19. A communication node, comprising:
a transceiver for communicating with user devices;
an intelligence gathering module that detects at least one signal from at least one other network device capable of communicating with user devices, wherein the intelligence gathering module processes information regarding the at least one other network device based on the at least one detected signal; and
a memory portion that at least temporarily includes an indication of the processed information and processed information regarding a communication history, wherein the node uses at least one of the indication or the processed information of the memory portion to (i) facilitate a communication for a user device, or (ii) obtain additional information regarding at least one other network device.

20. The communication node of claim 19, wherein the node communicates the information regarding the at least one other network device to a network controller for inclusion in stored information indicating possible communication links among communication devices within a selected region.
